(19) United States
(12) Patent Application Publication
(10) Pub. No.: US 2026/0036750 A1
(43) Pub. Date: Feb. 5, 2026

(54) LENS-TYPE OPTICAL FIBER ARRAY STACKING STRUCTURE

(71) Applicant: FOCI FIBER OPTIC COMMUNICATIONS, INC., HSINCHU (TW)

(72) Inventors: Ting-Ta Hu, HSINCHU (TW); Po-Yi Wu, HSINCHU (TW); Chieh-Yu Fang, HSINCHU (TW); Chia-Kuo Chen, HSINCHU (TW); Ting-Yan Lin, HSINCHU (TW)

(21) Appl. No.: 18/914,384

(22) Filed: Oct. 14, 2024

(30) Foreign Application Priority Data
Jul. 31, 2024 (TW) 113128591

(51) Int. Cl. G02B 6/36; G02B 6/38

(52) U.S. Cl. CPC G02B 6/3676; G02B 6/3636; G02B 6/3853

(57) ABSTRACT

The present invention relates to a lens-type optical fiber array stacking structure. Through the arrangement of two guide pins corresponding to the protruding ribs of the optical fiber array module, the arrangement of the concave-convex matching between the first passive alignment part and the second passive alignment part of two optical fiber array modules, the arrangement of the first supporting part of the docking end lens group and the first lens supporting platform of the substrate, and/or the arrangement of the second supporting part of the chip end lens group and the second lens supporting platform of the substrate, the optical fiber array module and each lens group can be passively positioned at the correct focal length during assembly, thereby improving yield and reducing costs.

### BACKGROUND OF THE INVENTION

### 1. Field of the Invention

The present invention relates generally to a technical field of optical fiber array stacking, and more particularly, to a lens-type optical fiber array stacking structure that can passively position the optical fiber array module and the lens group at the correct focal length.

### 2. The Prior Arts

In the current optical fiber array stacking technology, the lens group at the docking end and the lens group at the chip end must be aligned with each fiber in the optical fiber array to facilitate the light beam to continue traveling. In order to align each lens group with each optical fiber in the optical fiber array, an external mold must be used to position each lens and the optical fiber array during assembly to complete the alignment operation. However, the cost of mold manufacturing is high, and the structure of each model of product is different, resulting in the use of different molds for each model of product, which is very expensive; furthermore, even after alignment and assembly through the mold, there is no convenient method to confirm whether the positioning is at the correct focal length, resulting in low yield.

### SUMMARY OF THE INVENTION

A primary objective of the present invention is to provide a lens-type optical fiber array stacking structure. Through the arrangement of the two slide rails corresponding to the protruding ribs of the optical fiber array module, the arrangement of concave-convex matching between the respective first passive alignment part and the second passive alignment part of two optical fiber array modules, the arrangement of the first supporting part of the docking end lens group and the first lens supporting platform of the substrate, and/or the arrangement of the second supporting part of the chip end lens group and the second lens supporting platform of the substrate, the passive alignment and positioning is achieved, so that the fiber array module and each lens group can be passively positioned at the correct focal length during assembly, thereby improving yield and reducing costs.

In order to achieve the aforementioned objective, the present invention provides a lens-type optical fiber array stacking structure, including: a substrate, having at least one plate body, a first lens supporting platform and two slide rails, the first lens supporting platform extending upward from one side of the plate body, the two slide rails being disposed on the plate body, spaced apart and parallel to each other, a central axis of the first lens supporting platform and a central axis of each slide rail being mutually perpendicular, and the first lens supporting platform and each slide rail being spaced apart from each other; a docking end lens group, arranged on the first lens supporting platform of the substrate, and a bottom of the docking end lens group having a first supporting part, the first supporting part being positioned correspondingly to the first lens supporting platform; and two optical fiber array modules, one of which being flipped over to be combined with the other optical fiber array module to be disposed on the substrate, each optical fiber array module having a carrier plate and a plurality of optical fibers, an upper surface of the carrier plate having an accommodating part, a protruding rib protruding from a lower surface of the carrier plate opposite to the upper surface, the optical fibers being stacked in an array in the accommodating part and a central axis of each optical fiber being parallel to the central axis of each slide rail, wherein the protruding rib of an optical fiber array module being disposed between the two slide rails, and both sides of the protruding rib abutting respectively against the two slide rails for alignment and positioning; the carrier plate being provided with a first passive alignment part and a second passive alignment part on both sides of the accommodation part, wherein the first passive alignment part of one optical fiber array module and the second passive alignment part of the other optical fiber array module being aligned and positioned with each other, while the second passive alignment part of one optical fiber array module and the first passive alignment part of the other optical fiber array module being aligned and positioned with each other.

In some embodiments, both sides of the protruding rib are inclined surfaces, and each of the inclined surfaces is inclined toward the center of the protruding rib and abuts against each of the slide rails.

In some embodiments, the first passive alignment part is a concave groove, and the second passive alignment part is a convex strip.

n some embodiments, the concave groove is a V-shaped groove, a trapezoidal groove or a semicircular groove, and the convex strip is a V-shaped convex strip corresponding to the V-shaped groove, a trapezoidal convex strip corresponding to the trapezoidal groove or a semicircular convex strip corresponding to the semicircular groove.

In some embodiments, the two optical fiber array modules and the docking end lens group are combined through an optical matching glue.

In some embodiments, the substrate further includes a second lens supporting platform, which extends upward from the side of the plate body opposite to the first lens supporting platform.

In some embodiments, the lens-type optical fiber array stacking structure further includes a chip end lens group, a bottom of the chip end lens group has a second supporting part, and the second supporting part is positioned on the second lens supporting platform correspondingly.

In some embodiments, each slide rail has a semicircular cross section.

In some embodiments, the chip end lens group further includes a lens part disposed on a side of the chip end lens group opposite to the docking end lens group.

In some embodiments, a central axis of the second lens supporting platform and the central axis of each of the slide rails are perpendicular to each other, and the second lens supporting platform and each of the slide rails are spaced apart from each other.

In order to make the above objectives, features and advantages of the present invention more obvious and easy to understand, the specific embodiments listed in the drawings are described in detail below.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a schematic side view of a first embodiment of a lens-type optical fiber array stacking structure of the present invention.

FIG. 2 is a schematic perspective view of the substrate in the first embodiment of the lens-type optical fiber array stacking structure of the present invention.

FIG. 3 is a schematic perspective view of the first embodiment of the lens-type optical fiber array stacking structure of the present invention.

FIG. 4 is a schematic front view of the first embodiment of the lensed optical fiber array stacking structure of the present invention.

FIG. 5 is a schematic side view of the docking end lenses in the first embodiment of the lens-type optical fiber array stacking structure of the present invention.

FIG. 6 is a schematic rear view of the docking end lens group in the first embodiment of the lens-type optical fiber array stacking structure of the present invention.

FIG. 7 is a schematic front view of an optical fiber array module in the first embodiment of the lens-type optical fiber array stacking structure of the present invention.

FIG. 8 is a schematic perspective view of an optical fiber array module in the first embodiment of the lens-type optical fiber array stacking structure of the present invention.

FIG. 9 is a schematic front view of two optical fiber array modules aligned with each other in the first embodiment of the lens-type optical fiber array stacking structure of the present invention.

FIG. 10 is a schematic front view of two optical fiber array modules increasing the number of stacked layers in the first embodiment of the lens-type optical fiber array stacking structure of the present invention.

FIG. 11 is a schematic side view of a second embodiment of the lens-type optical fiber array stacking structure of the present invention.

FIG. 12 is a schematic side view of the chip end lens in the second embodiment of the lens-type optical fiber array stacking structure of the present invention.

FIG. 13 is a schematic perspective view of the chip end lens in the second embodiment of the lens-type optical fiber array stacking structure of the present invention.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

The accompanying drawings are included to provide further understanding of the invention, and are incorporated in and constitute a part of this specification. The drawings illustrate embodiments of the invention and, together with the description, serve to explain the principles of the invention.

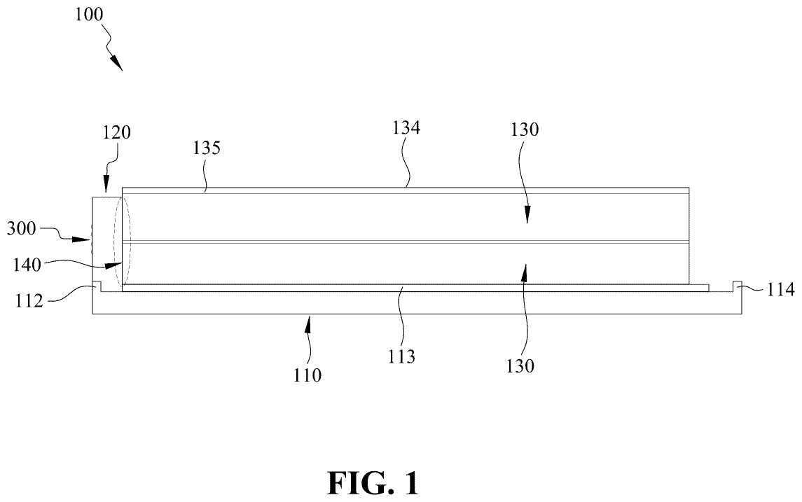

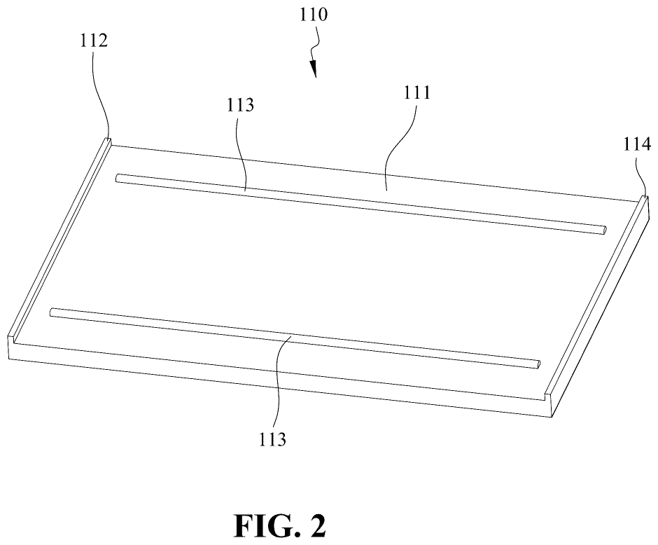

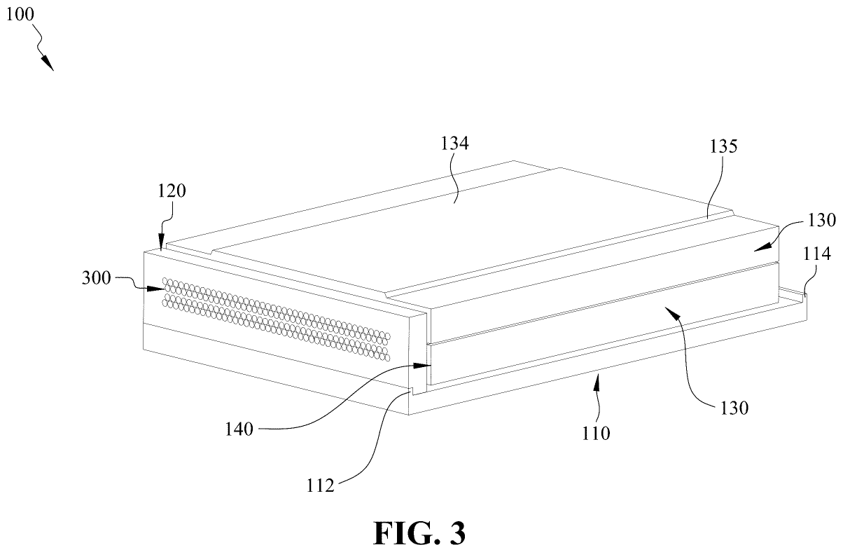

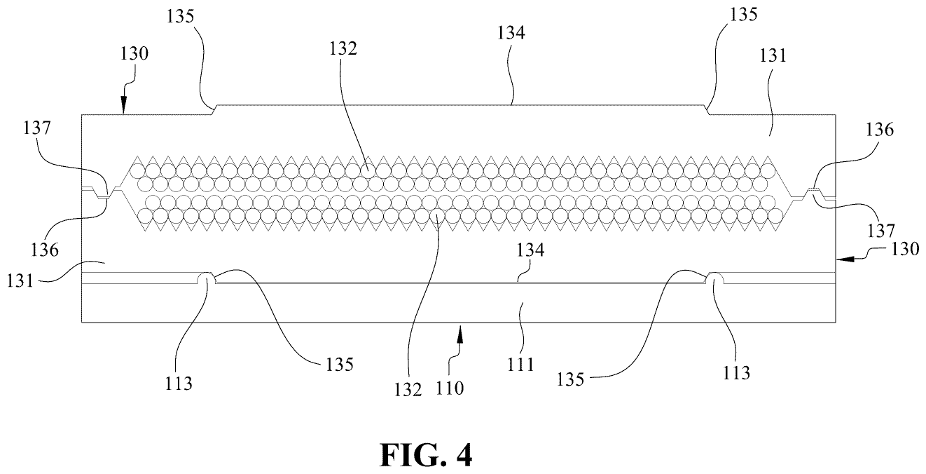

FIG. 1 is a schematic side view of a first embodiment of a lens-type optical fiber array stacking structure of the present invention; FIG. 2 is a schematic perspective view of the substrate in the first embodiment of the lens-type optical fiber array stacking structure of the present invention; FIG. 3 is a schematic perspective view of the first embodiment of the lens-type optical fiber array stacking structure of the present invention; and FIG. 4 is a schematic front view of the first embodiment of the lensed optical fiber array stacking structure of the present invention.

Refer to FIG. 1 and FIG. 2. The lens-type optical fiber array stacking structure 100 of the first embodiment of the present invention includes a substrate 110, a docking end lens group 120, and two optical fiber array modules 130.

Refer to FIG. 3. The substrate 110 of the present embodiment has a plate body 111, a first lens supporting platform 112, two slide rails 113, and a second lens supporting platform 114. The first lens supporting platform 112 extends upward from one side of the plate body 111 (e.g., the left side as shown in FIG. 3). The second lens supporting platform 114 may extend upward from the other side of the plate body 111 (e.g., the right side as shown in FIG. 3). In other words, the first lens supporting platform 112 and the second lens supporting platform 114 are respectively disposed on opposite sides of the plate body 111, and a central axis of the first lens supporting platform 112 and a center axis of the second lens supporting platform 114 are aligned with each other. The central axes are parallel to each other. The two slide rails are spaced apart from each other and arranged in parallel on the plate body 111. The central axis of the first lens supporting platform 112 and the central axis of the second lens supporting platform 114 are both perpendicular to a central axis of each slide rail 113. In addition, the first lens supporting platform 112 and the second lens supporting platform 114 are spaced apart from each slide rail 113. In some embodiments, as shown in FIG. 3, a cross section of each slide rail 113 is semicircular.

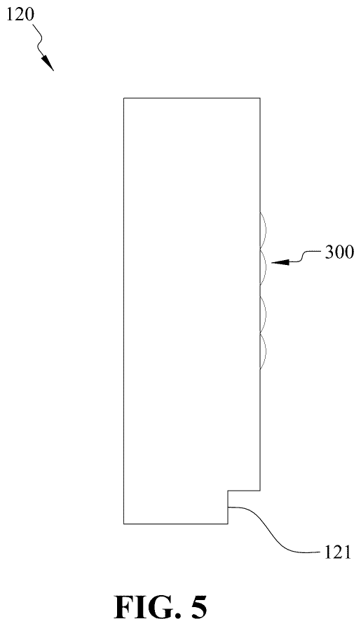

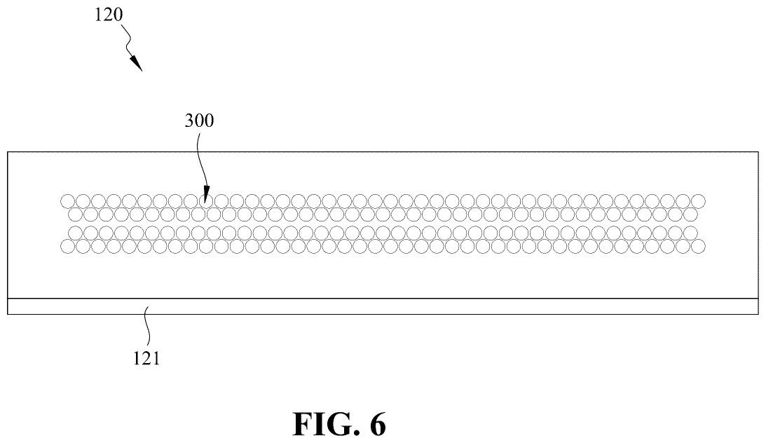

FIG. 5 is a schematic side view of the docking end lens group in the first embodiment of the lens-type optical fiber array stacking structure of the present invention; and FIG. 6 is a schematic rear view of the docking end lens group in the first embodiment of the lens-type optical fiber array stacking structure of the present invention.

Refer to FIGS. 1 to 6. The docking end lens group 120 is disposed on the first lens supporting platform 112 of the substrate 110. A bottom of the docking end lens group 120 has a first supporting part 121. In some embodiments, the first supporting part 121 can be correspondingly positioned and supported on the first lens supporting platform 112, thereby aligning and positioning the docking end lens group 120.

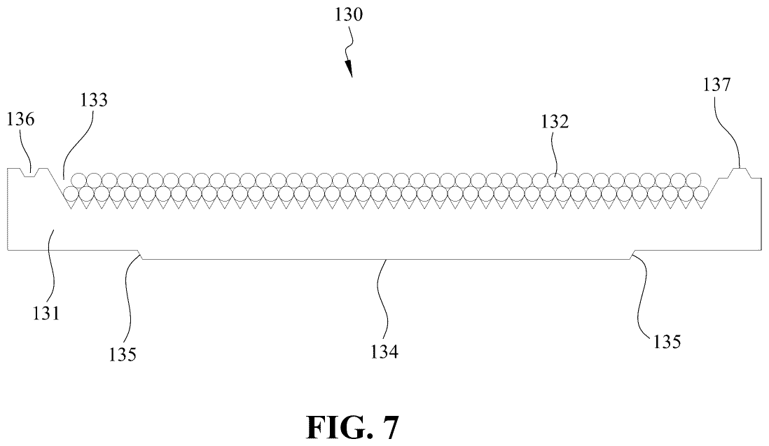

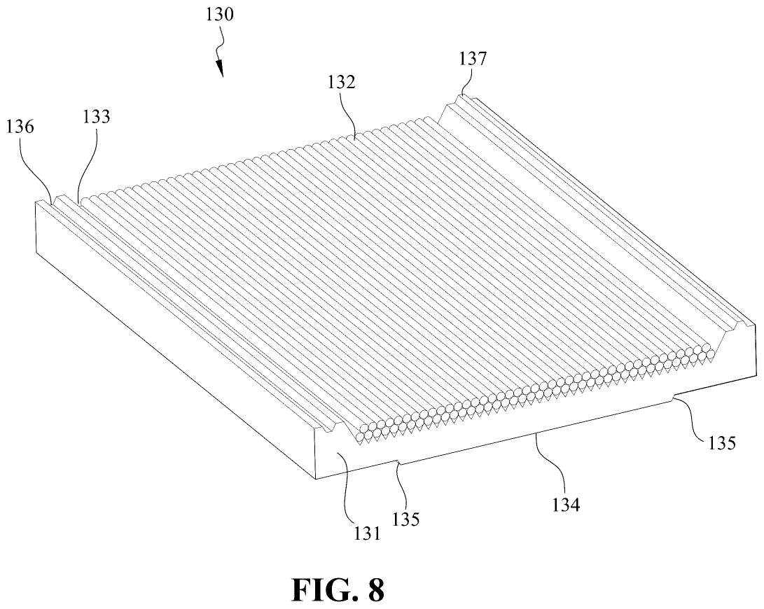

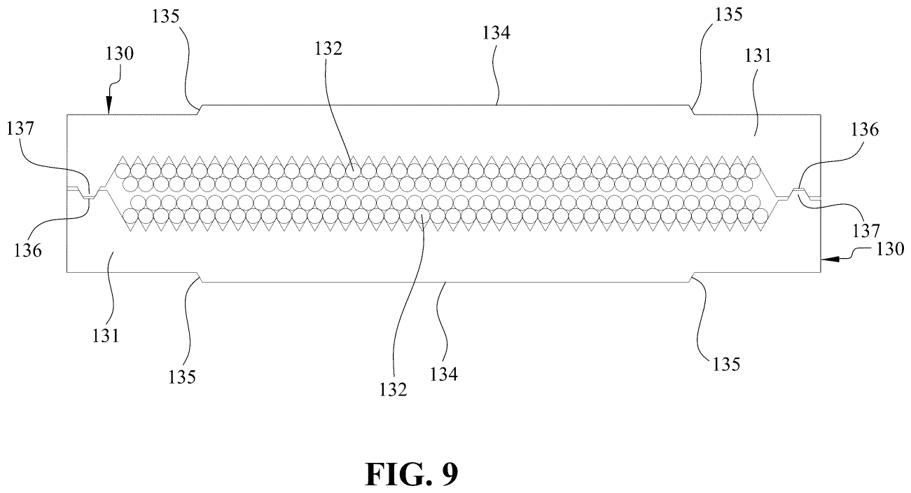

FIG. 7 is a schematic front view of an optical fiber array module in the first embodiment of the lens-type optical fiber array stacking structure of the present invention; FIG. 8 is a schematic perspective view of an optical fiber array module in the first embodiment of the lens-type optical fiber array stacking structure of the present invention; and FIG. 9 is a schematic front view of two optical fiber array modules aligned with each other in the first embodiment of the lens-type optical fiber array stacking structure of the present invention.

Refer to FIGS. 1 to 9. One of the two optical fiber array modules 130 (as shown in FIG. 9, the upper optical fiber array module 130) is flipped upside down to be combined with the other optical fiber array module 130 (as shown in FIG. 9, the lower optical fiber array module 130) to be disposed on the substrate 110. As shown in FIGS. 7 and 8, each optical fiber array module 130 has a carrier plate 131 and a plurality of optical fibers 132. An upper surface of the carrier plate 131 has a accommodation part 133, and a protruding rib 134 protrudes from a lower surface of the carrier plate 131 opposite to the upper surface. The optical fibers 132 are stacked in an array in the accommodation part 133 and a central axis of each optical fiber 132 is parallel to the central axis of each slide rail 113. Refer to FIG. 3 and FIG. 9, in which the protruding rib 134 of one optical fiber array module 130 (the lower optical fiber array module 130) is disposed between the two slide rails 113. The two sides of the protruding rib 134 respectively abut against the two slide rails 113 for alignment and positioning. In some embodiments, both sides of the protruding rib 134 are configured as inclined planes 135. Each inclined plane 135 is inclined toward the center of the protruding rib 134 and abuts against each slide rail 113. By the arrangement of the inclined plane 135 and the semicircular cross-section of the two slide rails 113, the interaction between the inclined planes and the slide rails allows the optical fiber array module 130 to be automatically aligned and positioned.

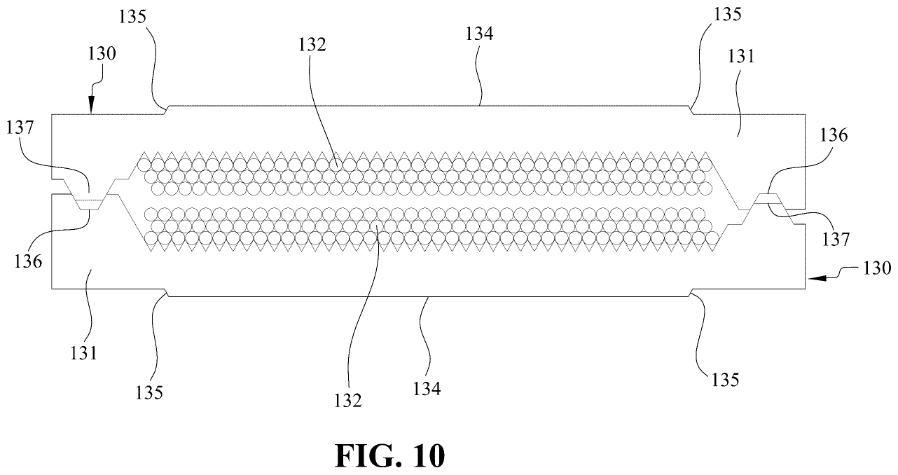

FIG. 10 is a schematic front view of two optical fiber array modules increasing the number of stacked layers in the first embodiment of the lens-type optical fiber array stacking structure of the present invention. In some embodiments, the number of optical fibers 132 or the number of stacks can be increased by improving (enlarging) the size of the accommodation part 133.

In some embodiments, the carrier plate 131 is provided with a first passive alignment part 136 and a second passive alignment part 137 on both sides of the accommodation part 133. Refer to FIG. 9, in which the first passive alignment part 136 of one optical fiber array module 130 (the upper optical fiber array module 130) and the second passive alignment parts 137 of the other optical fiber array module (the lower optical fiber array module 130) are aligned with each other, and the second passive alignment part 137 of one optical fiber array module 130 (the upper optical fiber array module 130) is aligned with the first passive alignment parts 136 of the other optical fiber array module 130 (the lower optical fiber array module 130). In some embodiments, the first passive alignment part 136 and the second passive alignment part 137 may have a concave-convex matching. For example, in the present embodiment, the first passive alignment part 136 can be a concave groove, and the second passive alignment part 137 can be a convex strip, or vice versa, but it is not limited thereto. In some embodiments, the first passive alignment part 136 that is a concave groove can be a V-shaped groove, a trapezoidal groove or a semicircular groove, and the second passive alignment part 137 that is a convex strip can be a V-shaped convex strip corresponding to a V-shaped concave groove, a trapezoidal convex strip corresponding to a trapezoidal concave groove, or a semicircular convex strip corresponding to a semicircular concave groove, but is not limited thereto. Therefore, through the arrangement of the first passive alignment part 136 and the second passive alignment part 137, the two optical fiber array modules 130 can be automatically aligned and positioned.

Therefore, through the interaction of the first supporting part 121 correspondingly positioned and supported on the first lens supporting platform 112, the docking end lens group 120 can be automatically aligned and positioned, and the disposition of the inclined surface 135 and the interaction with the slide rails 113 allow the optical fiber array module 130 to be automatically aligned and positioned, and an optical matching glue 140 is used to combine the two optical fiber array modules 130 and the docking end lens group 120 to reduce reflection, thereby making the optical fiber array modules 130 and the docking end lens group 120 can achieve the effect of passive positioning at the correct focal length.

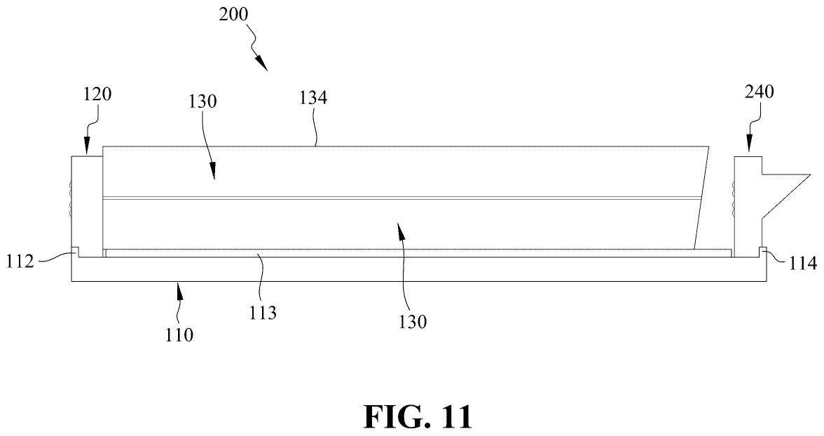

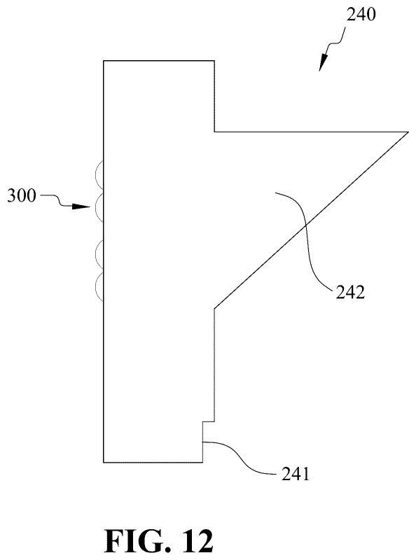

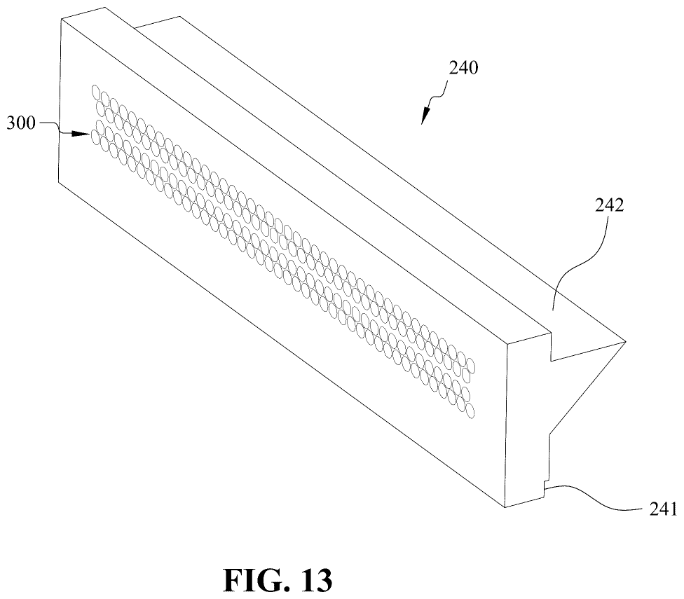

FIG. 11 is a schematic side view of a second embodiment of the lens-type optical fiber array stacking structure of the present invention; FIG. 12 is a schematic side view of the chip end lens in the second embodiment of the lens-type optical fiber array stacking structure of the present invention; and FIG. 13 is a schematic perspective view of the chip end lens in the second embodiment of the lens-type optical fiber array stacking structure of the present invention.

The second embodiment of the lens-type fiber array stacking structure 200 is similar to the first embodiment of the lens-type fiber array stacking structure 100. The difference lies in the addition of a chip end lens group. The components of the lens-type fiber array stacking structure 200 in the second embodiment are the same as the components of the lens-type optical fiber array stacking structure 100 in the first embodiment; that is, the same component numbers are used, and their functions and structures will not be described in detail.

Refer to FIG. 11. The second embodiment of the lens-type optical fiber array stacking structure 200 includes a substrate 110, a docking end lens group 120, two optical fiber array modules 130, and a chip end lens group 240; wherein, the substrate 110, the docking end lens group 120, and the two fiber array modules 130 of the present embodiment are the same as the substrate 110, the docking end lens group 120, and the two fiber array modules 130 of the first embodiment, and therefore will not be described again. In some embodiments, the docking end lens group 120 and the chip end lens group 240 each include a plurality of lenses 300 arranged in an array corresponding to the optical fibers 132 of the fiber array module 130, which is a well-known technology and will not be described in detail here.

Refer to FIG. 12 and FIG. 13. A bottom of the chip end lens group 240 has a second supporting part 241. The second supporting part 241 can be correspondingly positioned and supported on the second lens supporting platform 114.

In some embodiments, as shown in FIGS. 12 and 13, the chip end lens group 240 may further include a lens part 242. The lens part 242 can be disposed on a side of the chip end lens group 240 opposite to the docking end lens group 120 to change the path of the light beam through total reflection. For example, as shown in FIGS. 12 and 13, the light beam will pass through the lens part 242 and then change its path through total reflection, and then reflect and travel upward. In some embodiments, the lens part 242 can be changed into a lens to focus the light beam and apply edge coupling. Therefore, in the present embodiment, the docking end lens group 120 can be connected to an external connector (not shown), and the chip end lens group 240 can be connected to a chip (not shown), thereby completing and achieving efficacy of beam transmission.

In summary, the lens-type optical fiber array stacking structures 100 and 200 of the present invention can achieve passive alignment and positioning through the corresponding arrangement of the protruding ribs 134 (inclined surface 135) of the two optical fiber array modules 130 and the two slide rails 113, the arrangement of the concave-convex matching between the respective first passive alignment parts 136 and the second passive alignment part 137 of the two optical fiber array modules 130, and the arrangement of the first supporting part 121 of the docking end lens group 120 and the first lens supporting platform 112 of the substrate 110, and/or the second supporting part 241 of the chip end lens group 240 and the second lens supporting platform 114 of the substrate 110. As such, the fiber array modules 130 and the lens groups (including the docking end lens group 120 and/or the chip side lens group 240) can be passively positioned at the correct focal length during assembly to improve yield and reduce cost.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A lens-type optical fiber array stacking structure, comprising:
a substrate, having at least one plate body, a first lens supporting platform and two slide rails, the first lens supporting platform extending upward from one side of the plate body, the two slide rails being disposed on the plate body, spaced apart and parallel to each other, a central axis of the first lens supporting platform and a central axis of each slide rail being mutually perpendicular, and the first lens supporting platform and each slide rail being spaced apart from each other;
a docking end lens group, arranged on the first lens supporting platform of the substrate, and a bottom of the docking end lens group having a first supporting part, the first supporting part being positioned correspondingly to the first lens supporting platform; and
two optical fiber array modules, one of which being flipped over to be combined with the other optical fiber array module to be disposed on the substrate, each optical fiber array module having a carrier plate and a plurality of optical fibers, an upper surface of the carrier plate having an accommodating part, a protruding rib protruding from a lower surface of the carrier plate opposite to the upper surface, the optical fibers being stacked in an array in the accommodating part and a central axis of each optical fiber being parallel to the central axis of each slide rail, wherein the protruding rib of an optical fiber array module being disposed between the two slide rails, and both sides of the protruding rib abutting respectively against the two slide rails for alignment and positioning; the carrier plate being provided with a first passive alignment part and a second passive alignment part on both sides of the accommodation part, wherein the first passive alignment part of one optical fiber array module and the second passive alignment part of the other optical fiber array module being aligned and positioned with each other, while the second passive alignment part of one optical fiber array module and the first passive alignment part of the other optical fiber array module being aligned and positioned with each other.

2. The lens-type optical fiber array stacking structure according to claim 1, wherein both sides of the protruding rib are an inclined surface, and each of the inclined surfaces is inclined toward the center of the protruding rib and abuts against each of the slide rails.

3. The lens-type optical fiber array stacking structure according to claim 1, wherein the first passive alignment part is a concave groove, and the second passive alignment part is a convex strip.

4. The lens-type optical fiber array stacking structure according to claim 3, wherein the concave groove is a V-shaped groove, a trapezoidal groove or a semicircular groove, and the convex strip is a V-shaped convex strip corresponding to the V-shaped groove, a trapezoidal convex strip corresponding to the trapezoidal groove or a semicircular convex strip corresponding to the semicircular groove.

5. The lens-type optical fiber array stacking structure according to claim 1, wherein the two optical fiber array modules and the docking end lens group are combined through an optical matching glue.

6. The lens-type optical fiber array stacking structure according to claim 1, wherein the substrate further includes a second lens supporting platform, which extends upward from the side of the plate body opposite to the first lens supporting platform.

7. The lens-type optical fiber array stacking structure according to claim 6, wherein the lens-type optical fiber array stacking structure further includes a chip end lens group, a bottom of the chip end lens group has a second supporting part, and the second supporting part is positioned on the second lens supporting platform correspondingly.

8. The lens-type optical fiber array stacking structure according to claim 1, wherein each slide rail has a semicircular cross section.

9. The lens-type optical fiber array stacking structure according to claim 7, wherein the chip end lens group further includes a lens part disposed on a side of the chip end lens group opposite to the docking end lens group.

10. The lens-type optical fiber array stacking structure according to claim 6, wherein a central axis of the second lens supporting platform and the central axis of each of the slide rails are perpendicular to each other, and the second lens supporting platform and each of the slide rails are spaced apart from each other.
